(19) United States
(12) Patent Application Publication
(10) Pub. No.: US 2013/0224723 A1
(43) Pub. Date: Aug. 29, 2013

(54) DISPLAY BOARD ASSEMBLY

(71) Applicants: Anthony Gonzales, McKinney, TX (US); Julio Herrera, Irving, TX (US); Jeffrey Don Brownlee, Coppell, TX (US)

(72) Inventors: Anthony Gonzales, McKinney, TX (US); Julio Herrera, Irving, TX (US); Jeffrey Don Brownlee, Coppell, TX (US)

(73) Assignee: THE STANDARD REGISTER COMPANY, Dayton, OH (US)

(21) Appl. No.: 13/406,801

(22) Filed: Feb. 28, 2012

(51) Int. Cl. B43L 1/00

(52) U.S. Cl. 434/416

(57) ABSTRACT

An erasable marker board assembly includes a metal backing panel, a pre-printed poster and a transparent panel. The pre-printed poster bears unchanging information, and defines areas for additional information to be written by hand with an erasable marker. A transparent panel overlies the poster and provides a top surface upon which the additional information may be written with an erasable marker. The transparent panel may comprise a panel of glass or a panel of transparent acrylic material. A plurality of releasable fasteners secure the metal backing panel, the pre-printed poster, and the transparent panel together.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This relates to an erasable marker board assembly of the type which is used to display information that is written by hand on the assembly. Display boards, called “white boards,” have been widely used to permit the display of handwritten information. A user writes on such a board with an erasable marker, and the written information is clearly displayed until erased using a cloth or an eraser designed for the purpose.

White boards of this type have been widely used in hospital rooms to display information about the patient in the room and the nursing staff attending to the patient. The white board may display the names of the nurses, doctors, and other staff attending the patient. The white board may also indicate the level of pain experienced by the patient, and the goals for the patient to achieve before discharge, as well as other information that is important to the patient. Various other items of information may be displayed, which will vary from patient to patient. Areas on the white board are typically delineated with permanently printed graphics and labels to indicate the nature of the information that the staff and patient should write on the white board in various areas. Additionally, the white board will typically include permanently printed information that will not change from patient to patient, such as the name and logo of the hospital, the room number, the telephone number of the room, and other instructional information.

While a white board of this type is very useful in helping the staff and patient keep track of matters affecting the patient's health and the progress of the patient's treatment, such a white board is expensive. Replacing hospital white boards, when the hospital name or logo changes, when the telephone number of the hospital room changes, when Joint Commission or Regulatory rules or laws are implemented that require posting different information, or when posting different explanatory information for the patient or staff becomes desirable, is a financial burden. There is a need for an erasable marker board assembly in which changing the pre-printed information can be accomplished simply and economically.

### SUMMARY

An erasable marker board assembly includes a metal backing panel, a pre-printed poster and a transparent panel. The pre-printed poster bears unchanging information, and defines areas for additional information to be written by hand with an erasable marker. A transparent panel overlies the poster and provides a top surface upon which the additional information may be written with an erasable marker.

The transparent panel may comprise a panel of glass. Alternatively, the transparent panel may comprise a panel of transparent acrylic material. A plurality of releasable fasteners may be provided to secure the metal backing panel, the pre-printed poster, and the transparent panel together. The plurality of releasable fasteners may extend from the metal panel on the back of the erasable marker board assembly to engage a wall and to support the assembly on the wall. The releasable fasteners may include expandable devices for securing the erasable marker board assembly to a hollow wall. The assembly may be mounted flush to the wall or may be mounted in such a way that is raised from the wall surface. The metal backing panel may be a polymetal panel, or a stiff panel made of other suitable material, such as PVC.

An erasable marker board assembly includes a pre-printed poster, a transparent panel, and a plurality of releasable fasteners. The pre-printed poster bears unchanging information, and further defines areas for additional information to be written by hand. The transparent panel overlies the poster and provides a top surface upon which the additional information may be written with an erasable marker. A plurality of releasable fasteners may be provided to secure the pre-printed poster, and the transparent panel to a vertical surface, with the transparent panel covering the pre-printed poster. The plurality of releasable fasteners may engage a vertical surface and support the assembly on the vertical surface. The releasable fasteners may include expandable devices for securing the erasable marker board assembly to a hollow wall. The transparent panel may comprise a panel of glass, or a panel of transparent acrylic material.

An erasable marker board assembly includes a backing panel, a poster defining areas for information, and a transparent panel overlying the areas for additional information. The transparent panel provides a top surface upon which the information may be written with an erasable marker. The transparent panel may comprise a panel of glass or a panel of transparent acrylic material. The assembly may further include a plurality of releasable fasteners which secure together the backing panel, the poster, and the transparent panel. The plurality of releasable fasteners may extend from the backing panel on the back of the erasable marker board assembly to engage a wall and support the assembly on the wall. The releasable fasteners may include expandable devices for securing the erasable marker board assembly to a hollow wall. The backing panel may be a polymetal panel.

### BRIEF DESCRIPTION OF THE DRAWINGS

FIG. 1 is a view, showing an embodiment of the erasable marker board assembly;

FIG. 2 is a view of a pre-printed poster bearing unchanging information, and further defining areas for additional information;

FIG. 3 is a partial, exploded view of the erasable marker board assembly; and

FIG. 4 is enlarged, partial, sectional view, showing the manner in which the board assembly is mounted on a hollow wall.

### DETAILED DESCRIPTION

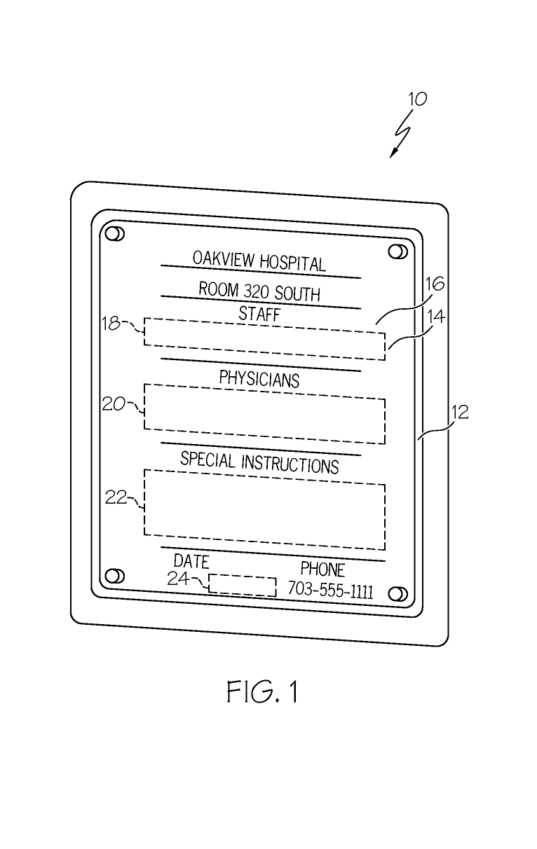

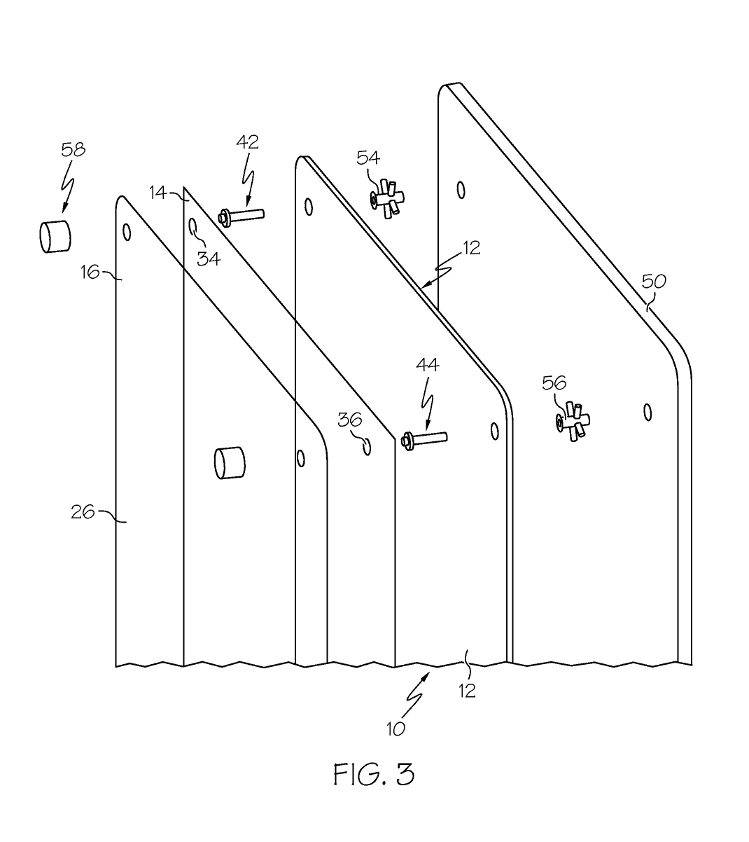

Reference is made to FIG. 1, illustrating an embodiment of the erasable marker board assembly 10, and FIG. 3, showing the upper portion of the assembly 10 in an exploded view. The assembly 10 includes a metal backing panel 12, a pre-printed poster 14, and a transparent panel 16. As seen in FIG. 1, the pre-printed poster 14 carries unchanging information, such as “OAKVIEW HOSPITAL,” “ROOM 320 SOUTH,” and “PHONE 703-555-1111,” as well as labels, such as “STAFF,” “PHYSICIANS,” and “SPECIAL INSTRUCTIONS,” and “DATE,” for areas 18, 20, 22, and 24, respectively. Areas 18, 20, 22, and 24, indicated generally in dashed lines, are provided to permit the listed additional information to be written by hand on the assembly with an erasable marker, preferably a low odor dry erasable marker. The pre-printed poster 14 may be made of paper or the like. The transparent panel 16 overlies the poster 14 and provides a top surface 26 upon which the additional information may be written with an erasable marker. The transparent panel 16 may comprise a transparent panel of glass or an acrylic material which protects the poster 14 and which provides a surface 26 from which the handwritten information may be easily erased. The backing panel 12 may be made of metal material, such as a polymetal material, to give the assembly 11 an attractive, finished appearance. Alternatively, the backing panel 12 may be made of a relatively stiff polymer material, such as a PVC material, which is finished in visually appealing motif or color.

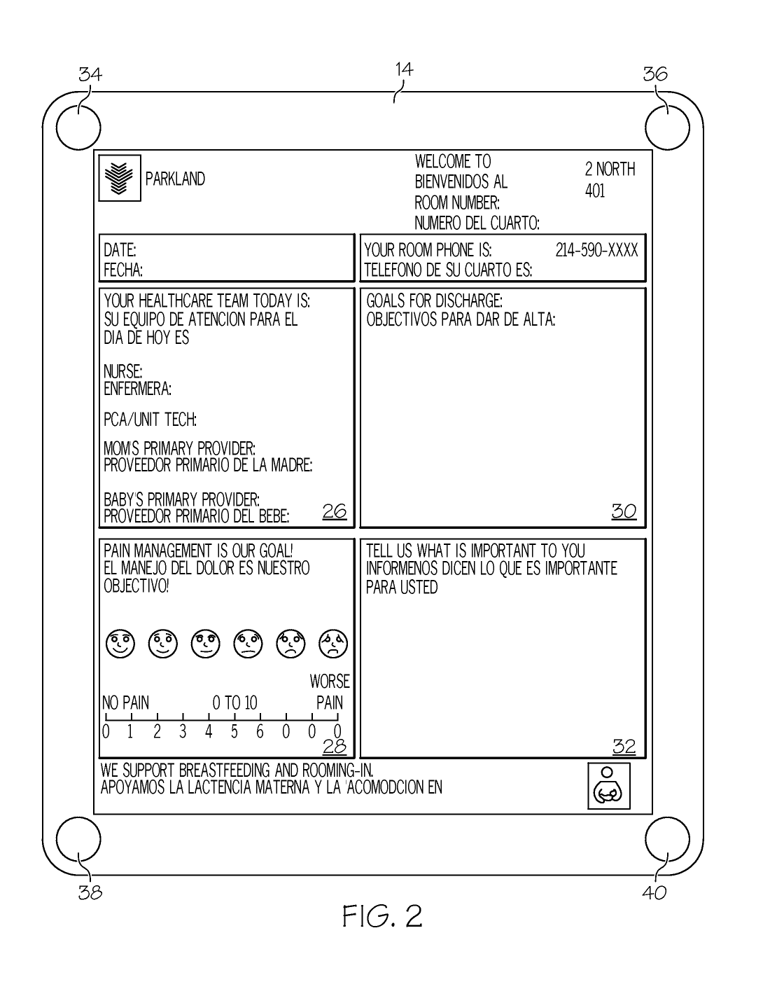

FIG. 2 illustrates another pre-printed poster 14, differing somewhat from the pre-printed poster 14 shown in FIG. 1, bearing unchanging information, such as “Parkland,” 2 North 401,” “214-590-7XXX,” and “We support breastfeeding and rooming-in,” as well as labels “Your healthcare team today is,” “Nurse,” “PCA/Unit Tech,” “Mom's Primary Provider,” “Baby's Primary Provider,” “Goals for Discharge,” and “Tell us what is important to you” for areas 26, 28, 30, and 32. Areas 26, 28, 30, and 32 are provided to permit specific additional information to be written by hand on the assembly 10 with an erasable marker. The poster 14 defines holes 34, 36, 38 and 40 through which releasable fasteners extend. FIG. 3 shows the two upper releasable fasteners 42 and 44. It will be appreciated, however, that this embodiment contemplates four releasable fasteners, one fastener adjacent each of the four corners of the assembly 10. FIG. 3, however, shows only the two upper fasteners 42 and 44 for simplicity.

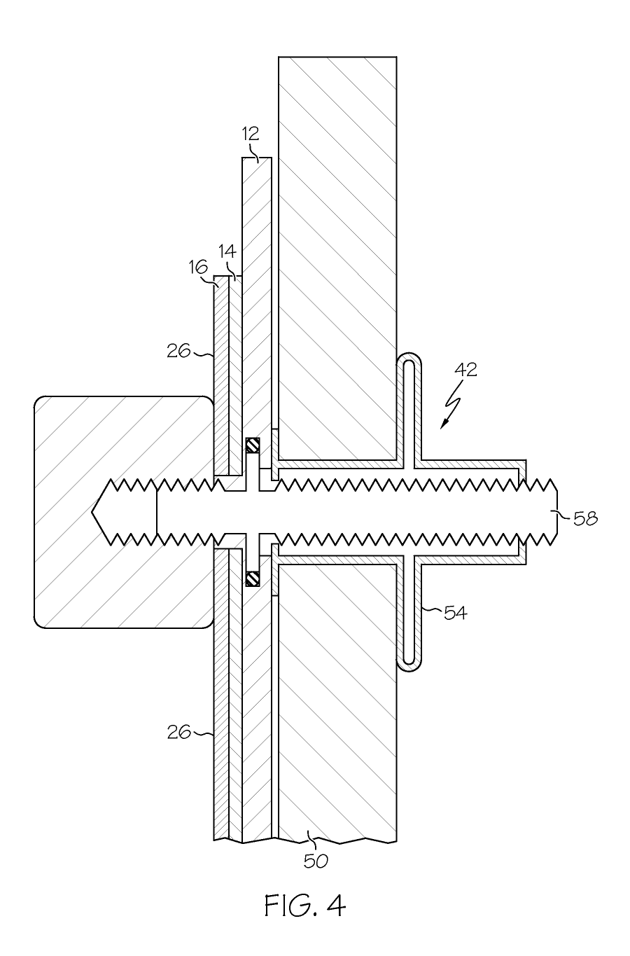

The releasable fastener 42 is shown in greater detail in FIG. 4. The plurality of releasable fasteners secure the metal backing panel 12, the pre-printed poster 14, and the transparent panel 16 together. Each of the plurality of releasable fasteners extends from the metal backing panel 12 on the back of the erasable marker board assembly 10 to engage the wall 50 and to support the assembly 10 in position on the wall 50. The releasable fasteners each include expandable devices 52, such as molybolt arrangements 54 and 56, for securing the erasable marker board assembly 10 to a hollow wall 50. The fastener 42 has a central, threaded post 58 which engages and expands the molybolt 54 and also extends through holes in the poster 14 and the transparent panel 16. A decorative nut 60 is treaded onto the post 58 and holds the backing panel 12, the pre-printed poster 14, and the transparent panel 16 in position. As shown, the assembly 10 is substantially flush with the wall 50. If desired, however, spacers may be provided on post 58 of each fastener 42 to position the assembly 10 away from the surface of the wall 50.

It will be appreciated that when any change is required in the pre-printed information or the labels displayed on the assembly 10, all that is required is for a new, relatively inexpensive poster 14 to be created, and inserted between panels 12 and 16. This simplifies and reduces significantly the cost of making such changes.

What is claimed is:

1. An erasable marker board assembly, comprising:
a metal backing panel,
a pre-printed poster bearing unchanging information, and further defining areas for additional information to be written by hand, and
a transparent panel overlying the poster and providing a top surface upon which said additional information may be written with an erasable marker.

2. The erasable marker board assembly of claim 1, in which said transparent panel comprises a panel of glass.

3. The erasable marker board assembly of claim 1, in which said transparent panel comprises a panel of transparent acrylic material.

4. The erasable marker board assembly of claim 1, further comprising a plurality of releasable fasteners which secure said metal backing panel, said pre-printed poster, and said transparent panel together.

5. The erasable marker board assembly of claim 4, in which said plurality of releasable fasteners extend from said metal backing panel on the back of said erasable marker board assembly to engage a wall and support said assembly on said wall.

6. The erasable marker board assembly of claim 5, in which said releasable fasteners include expandable devices for securing said erasable marker board assembly to a hollow wall.

7. The erasable marker board assembly of claim 1, in which said metal backing panel is a polymetal panel.

8. An erasable marker board assembly, comprising:
a pre-printed poster bearing unchanging information, and further defining areas for additional information to be written by hand,
a transparent panel overlying the poster and providing a top surface upon which said additional information may be written with an erasable marker, and
a plurality of releasable fasteners which secure said pre-printed poster, and said transparent panel to a vertical surface, with said transparent panel covering said pre-printed poster.

9. The erasable marker board assembly of claim 8, in which said transparent panel comprises a panel of glass.

10. The erasable marker board assembly of claim 8, in which said transparent panel comprises a panel of transparent acrylic material.

11. The erasable marker board assembly of claim 8, in which said plurality of releasable fasteners engage a vertical surface and support said assembly on said vertical surface.

12. The erasable marker board assembly of claim 11, in which said releasable fasteners include expandable devices for securing said erasable marker board assembly to a hollow wall.

13. An erasable marker board assembly, comprising:
a backing panel,
a poster defining areas for information, and
a transparent panel overlying the areas for additional information and providing a top surface upon which said information may be written with an erasable marker.

14. The erasable marker board assembly of claim 13, in which said transparent panel comprises a panel of glass.

15. The erasable marker board assembly of claim 13, in which said transparent panel comprises a panel of transparent acrylic material.

16. The erasable marker board assembly of claim 13, further comprising a plurality of releasable fasteners which secure together said backing panel, said poster, and said transparent panel.

17. The erasable marker board assembly of claim 16, in which said plurality of releasable fasteners extend from said backing panel on the back of said erasable marker board assembly to engage a wall and support said assembly on said wall.

18. The erasable marker board assembly of claim 17, in which said releasable fasteners include expandable devices for securing said erasable marker board assembly to a hollow wall.

19. The erasable marker board assembly of claim 1, in which said backing panel is a polymetal panel.
